(19) United States
(12) Patent Application Publication
(10) Pub. No.: US 2025/0286065 A1
(43) Pub. Date: Sep. 11, 2025

(54) ULTRA-CONFORMAL FLUORINATED POLYMER COATING ON LI-METAL BY SOLID-LIQUID-SOLID PHASE CONVERSION USING PHYSICAL TREATMENT

(71) Applicant: Drexel University, Philadelphia, PA (US)

(72) Inventors: Krishna Kumar Sarode, Nizamabad, Telangana (IN); Vibha Kalra, Ithaca, NY (US)

(73) Assignee: Drexel University, Philadelphia, PA (US)

(21) Appl. No.: 18/859,643

(22) PCT Filed: Apr. 25, 2023
(86) PCT No.: PCT/US2023/066151

§ 371 Date: Oct. 24, 2024

Related U.S. Application Data
(60) Provisional application No. 63/363,497, filed on Apr. 25, 2022.

(51) Int. Cl. H01M 4/62; H01M 10/0525; H01M 10/0562

(52) U.S. Cl. CPC H01M 4/62; H01M 10/0562; H01M 10/0525; H01M 2300/0065

(57) ABSTRACT

Methods of making an artificial solid electrolyte interphase protected anode, including steps of: a) applying a fluoropolymer film to a lithium metal surface to form a coated lithium metal surface, b) applying pressure to the fluoropolymer film on the coated lithium metal surface, c) subsequent to step b), dissolving at least part of the fluoropolymer film on the coated lithium metal surface in a solvent; d) applying pressure to the at least partially dissolved fluoropolymer film on the coated lithium metal surface of step c); and e) evaporating the solvent to form the artificial solid electrolyte interphase protected anode. An anode formed by the method and cells and batteries employing the anode.

### CROSS REFERENCE TO RELATED APPLICATIONS

This application claims the benefit of U.S. Provisional Application No. 63/363,497, filed on Apr. 25, 2022, the entire disclosure of which is hereby incorporated by reference as if set forth fully herein.

### BACKGROUND OF THE INVENTION

Lithium-sulfur batteries are considered the most promising next-generation energy storage system due to their low cost and high theoretical energy density, which is about 2500 W·h/kg, based on the weight of the battery. However, their applications are hindered by poor electrochemistry, which is ascribed to issues related to the use of ether-based electrolytes having a low boiling point, polysulfide shuttling and/or Li-metal stability.

Li—S batteries can potentially deliver a practical energy density ranging from 250 to 500 W·h/kg·¹ This energy density is three times higher than that of commercial Li-ion batteries, which typically have an energy density ranging from 150-220 W·h/kg·² State-of-the-art Li—S batteries use ether-based electrolytes that have a number of disadvantages. First, the intermediate product, polysulfide, that is generated during battery cycling is highly soluble in the ether-based electrolyte, diffuses to the Li metal anode and corrodes the Li metal. This phenomenon is referred as polysulfide shuttling which also results in loss of active sulfur.³ Further, ether-based solvents have low flash points and are highly volatile which limits battery application at elevated temperatures. Therefore, practical use of ether-based electrolytes poses safety concerns.⁴

The above-mentioned problems associated with ether-based electrolytes can be alleviated by using a carbonate-based electrolyte. Many commercial Li-ion batteries employ carbonate-based electrolytes due to their broad range of operating temperatures and stability over large voltage windows.^{5,6} Thus, one option is to replace ether-based electrolytes with carbonate-based electrolytes to assist with practical realization of safe, stable and high energy density Li—S batteries. There are previous reports of Li—S batteries with carbonate electrolytes demonstrating stable and safe cycling performance.^{7,8} However, nearly all carbonate-based electrolytes in Li—S need unique sulfur cathodes to achieve the required reversible Li—S reactions.

The requirement for the Li—S electrochemical reaction to be reversible in carbonate-based electrolyte requires strong covalent bonding to the polymer host⁹ or confinement of short chain sulfur in a microporous structure.¹⁰ However, these configurations can only accommodate a limited amount of sulfur (typically <40 wt. % in the complete electrode) and only permit minimal areal loading. Hence, the low sulfur loading needed to accommodate the carbonate-based electrolyte is a potential drawback when trying to provide a high energy density Li—S battery with a carbonate electrolyte. Another critical and most significant downside is the instability of Li-metal in carbonate-based electrolytes. Li-metal degrades rapidly in carbonate-based electrolyte by dendrite and dead lithium formation thus showing poor electrochemical performance.^{11,12} To achieve practical application of Li—S batteries in carbonate electrolytes there is a need for a cathode with a high sulfur loading and a stable form of the lithium.

The major reason for Li-metal battery failure is the formation of microporous and mossy structures. These mossy structures are covered by a passive layer referred to as the solid electrolyte interphase (SEI) that separates the mossy lithium micro particles from a current collector. These individually separated Li-microparticles are termed “dead lithium” since they result in a rapid capacity fade.^{13,14} The porous nature of dead lithium increases the surface area thereby facilitating an increase in the side reactions which consume the electrolyte.

There have been many strategies proposed to minimize dead lithium formation and maintain the electrical contact between the deposited Li-metal particles and the current collector.¹⁵ A few of the reports are directed to reducing the electrolyte reactivity with the lithium metal such as by using a highly concentrated electrolyte,¹⁶ employing a fluorinated electrolyte,¹⁷ passivating the Li-metal surface with additives,¹⁸ 3D architecture for reducing the local current density and directed Li-ion deposition¹⁹ while imparting high external mechanical pressure to promote smooth deposition of the Li-metal.²⁰ The most successful strategy for preventing/minimizing dead lithium formation is the provision of a conformal LiF coating on the lithium metal. LiF is the most efficient protective material and has a broad electrochemical window of stability. A LiF containing SEI has been formed by adding fluorinated compounds/hydrogen fluoride (HF) into the electrolyte.²¹ After that, additives forming LiF have been used to form a stable SEI that results in uniform plating.

Lei Fan, et al. Regulating Li deposition at artificial solid electrolyte interphases, J. Mater. Chem. A, 2017, 5, 3483-3492, relates to an artificial LiF SEI on Li-metal prepared by sputter deposition. Li-metal with sputter deposited LiF has demonstrated a coulombic efficiency of 99% compared to bare Lithium.²²

Zhao et al. relates to an artificial LiF layer on Li-metal prepared by heating an amorphous fluoropolymer (CYTOP®) at a temperature ranging between 175° C. to 250° C. during which F₂ gas is generated that reacts with Li-metal. This process resulted in a LiF layer with a thickness of 380 nm via a continuous 12 hour reaction. Symmetrical cell testing of LiF coated Li showed a constant overvoltage of +/−0.15V. It also demonstrated a stable capacity of 1000 mAh/g after 100 cycles.²³

Wang et al. made an artificial LiF SEI by using a fast precipitation reaction with 1-butyl-2,3-dimethylimidazolium tetrafluoroborate. This LiF SEI was shown to be stable over a potential of +/−8-mV and exhibited a stable capacity of 144.2 mAh/g after 100 cycles, with a coulombic efficiency of 99.2%. 24 Facile in situ LiF coating on Li-metal by liquid/solid phase fluorination using polyvinylidene fluoride (PVDF)-DMF solution was also reported.²⁵

Another report described an in situ LiF-defluorinated polymer composite coating on Li-metal derived from PTFE film using roll pressing with Li-metal.²⁶ These two in situ methods produced the desired conformal coating but the coating was found to be a low quality, non-continuous LiF coating where LiF particles form partially linked grain boundaries that will fracture easily during lithium plating and stripping.

### SUMMARY

The present invention may be described by the following sentences:

1. In a first aspect, the present invention relates to a method of making an artificial solid electrolyte interphase protected anode, comprising steps of:
a. applying a fluoropolymer film to a lithium metal surface to form a coated lithium metal surface,
b. applying pressure to the fluoropolymer film on the coated lithium metal surface,
c. subsequent to step b), dissolving at least part of the fluoropolymer film on the coated lithium metal surface in a solvent;
d. applying pressure to the at least partially dissolved fluoropolymer film on the coated lithium metal surface of step c); and
e. evaporating the solvent to form the artificial solid electrolyte interphase protected anode.

2. The method of sentence 1, wherein the fluoropolymer film of step a) may be prepared by:
dissolving the fluoropolymer in an organic solvent at a weight ratio of fluoropolymer to solvent of 1:0.5 to less than 1:9, or a weight ratio of fluoropolymer to solvent of about 1:1 to form a fluoropolymer solution;
applying the fluoropolymer solution to a surface; and evaporating the solvent to form the fluoropolymer film.

3. The method of any one of sentences 1-2, wherein the fluoropolymer film may have a thickness of about 1 μm-15 μm, or from about 8 μm-10 μm.

4. The method of any one of sentences 1-3, wherein the fluoropolymer may be selected from the group consisting of polyvinylidene fluoride, and polyvinylidene fluoride-hexafluoropropylene, or the fluoropolymer is polyvinylidene fluoride-hexafluoropropylene.

5. The method of any one of sentences 1-4, wherein the solvent may be an organic solvent, or the solvent may be selected from the group consisting of dimethyl formamide and acetone.

6. The method of any one of sentences 1-5, wherein each step of applying pressure may be carried out by roll pressing at about 0.1 rpm to 0.5 rpm, or at about 0.328 rpm.

7 The method of any one of sentences 1-6, wherein the step c) of dissolving at least part of the fluoropolymer film may partially defluorinate the fluoropolymer such that the artificial solid electrolyte interphase protected anode comprises a molar ratio of C—F bonds to Li—F bonds of 1:1 to 5:1, or from about 1.2:1 to 3:1, or from about 1.8:1 to 2.2:1.

8. The method of any one of sentences 1-7, wherein the artificial solid electrolyte interphase protected anode may have a total thickness of from about 1 μm-100 μm, or from about 2 μm to about 75 μm, or from about 3 μm to about 50 μm.

9 The method of any one of sentences 1-8, wherein step c) may be carried out using a microporous membrane separator, and, optionally, the microporous membrane separator may comprise a material selected from the group consisting of polypropylene or polyethylene.

10. The method of any one of sentences 1-9, wherein each said evaporating step may be carried out by air drying.

11. In a second aspect, the present invention relates to an artificial solid electrolyte interphase protected anode prepared by the method of any one of sentences 1-10.

12. In a third aspect, the present invention relates to a cell comprising the artificial solid electrolyte interphase protected anode of sentence 11, an electrolyte, and a cathode.

13. The cell of sentence 12, wherein the cathode may comprise one or more of sulfur, graphite, sulfurized carbon, LiFePO₄ (LFP), LiMn₂O₄ (LMO), lithium nickel manganese spinel (LNMO), lithium cobalt oxide, V₂O₅, lithium nickel cobalt manganese oxide (NMC), and electrically conductive polymers.

14. The cell of any one of sentences 12-13, wherein the cathode may be prepared by:
a) mixing a conductive polymer, a nitrogen-containing polymer, or a combination of a conductive polymer and a nitrogen-containing polymer with sulfur in the presence of a solvent to form a mixture, wherein a weight ratio of the conductive polymer and/or nitrogen containing polymer to the sulfur is from about 1:2 to about 1:8; and
b) heating the mixture to a temperature of from about 250° C. to about 400° C. under a pressure of from about 0.05 bar to about 2.0 bar to form the cathode.

15. The cell of any one of sentences 12-14, wherein the electrolyte may be a carbonate electrolyte, and, optionally, the carbonate electrolyte may be selected from the group consisting of ethylene carbonate, dimethylcarbonate, methylethyl carbonate, diethylcarbonate, propylene carbonate, vinylene carbonate, allyl ethyl carbonate, and mixtures thereof.

16. In a fourth aspect, the present invention relates to a battery including one or more of the cells according to any one of sentences 12-15.

17. The battery of sentence 16, may have an energy density of about 450 W-h/kg to about 700 W-h/kg, or about 450 W-h/kg to about 670 W-h/kg, or about 450 W-h/kg to about 600 W-h/kg, or about 450 W-h/kg to about 500 W-h/kg, based on the weight of the battery.

18. In a fifth aspect, the present invention relates to an artificial solid electrolyte interphase protected anode comprising:
a partially defluorinated fluoropolymer matrix, and
lithium fluoride dispersed in the partially defluorinated fluoropolymer matrix.

19. The artificial solid electrolyte interphase protected anode of sentence 18, may comprise a molar ratio of C—F bonds to Li—F bonds of no less than 1, or from about 1:1 to 2.5:1.

20. The artificial solid electrolyte interphase protected anode of any one of sentences 18-19, wherein the fluoropolymer may be selected from the group consisting of polyvinylidene fluoride, and polyvinylidene fluoride-hexafluoropropylene, or the fluoropolymer is polyvinylidene fluoride-hexafluoropropylene.

### BRIEF DESCRIPTION OF THE DRAWINGS

FIG. 1 shows Fourier-transform infrared spectroscopy (FTIR) of the sulfurized polyacrylonitrile (SPAN) with high sulfur percentage synthesized in the closed system with ethanol wetting.

FIG. 2 shows Scanning Electron Microscopy (SEM) images that show a comparison of particle size between the composites synthesized in a closed system with ethanol wetting (left) and without ethanol wetting (right).

FIG. 3A shows the cyclic voltammetry of a SPAN-Li cathode half-cell at a scan rate of 0.2 mV/sec.

FIG. 3B shows a comparison of the cycle life of a SPAN cathode synthesized in a closed system with ethanol wetting and without ethanol wetting at a C/2 rate.

FIG. 3C shows a voltage profile of a SPAN cathode synthesized in a closed system with ethanol wetting.

FIG. 3D shows a voltage profile of a SPAN cathode synthesized in a closed system without ethanol wetting.

FIG. 3E shows a comparison of the voltage profile of the SPAN cathode synthesized in a closed system with ethanol wetting and in a open system without ethanol wetting.

FIG. 3F shows the cycle life of the SPAN cathode synthesized in a closed system with ethanol wetting, represented by the high sulfur line and in an open system without ethanol wetting, represented by the low sulfur line.

FIG. 4 shows a comparison of the FTIR spectrum of the Li-metal surface coated with poly(vinylidenefluoride-co-hexafluoropropylene):dimethylformamide (PVDF-HFP:DMF) (1:1) and poly(vinylidenefluoride)-dimethylformamide (PVDF-DMF) (4% solution)

FIG. 5 shows SEM images of the Li-metal with PVDF-DMF coating in images A)-C). Image A) shows a cross-sectional view before cycling. Image B) shows a top view before cycling. Image C) shows a top view after 10 cycles. Images D)-F) show an Li-metal with a PVDF-HFP:DMF coating. Image D) shows a cross-sectional view before cycling. Image E) shows a top view before cycling. Image F) shows a top view after 10 cycles.

FIG. 6A shows X-ray photoelectron spectroscopy (XPS) spectra of polyvinylidene fluoride (PVDF).

FIG. 6B shows XPS spectra of PVDF coated on Li-metal.

FIG. 6C shows XPS spectra of cycled Li-metal coated with PVDF.

FIG. 6D shows XPS spectra of PVDF-HFP.

FIG. 6E shows XPS spectra of PVDF-HFP coated on lithium.

FIG. 6F shows XPS spectra of cycled Li-metal coated with PVDF-HFP.

FIG. 7A shows voltage profiles of a pouch cell comprising a SPAN cathode with different types of lithium.

FIG. 7B shows capacity vs cycle life of a pouch cell comprising a SPAN cathode with different types of lithium.

### DETAILED DESCRIPTION OF THE EMBODIMENTS

The present disclosure relates to a method of making an artificial solid electrolyte interphase protected anode, comprising steps of:
a. applying a fluoropolymer film to a lithium metal surface to form a coated lithium metal surface,
b. applying pressure to the fluoropolymer film on the coated lithium metal surface,
c. subsequent to step b), dissolving at least part of the fluoropolymer film on the coated lithium metal surface in a solvent;
d. applying pressure to the at least partially dissolved fluoropolymer film on the coated lithium metal surface of step c); and
e. evaporating the solvent to form the artificial solid electrolyte interphase protected anode.

The present invention relates to lithium anodes for cells and batteries such as sulfur (Li—S) pouch cells in carbonate-based electrolyte using a variety of different types of cathodes and Li—metal as anode, and methods for making them. The influence of an artificial SEI (LiF and polymeric composite) using polymers on the electrochemical performance of the Li—S pouch cell was evaluated by galvanostatic cycling herein. Inspired by the galvanostatic cycling of Li—S pouch cell results attained by modifying individual components, a combination was made that consolidates the advanced components into one system thus improving the electrochemical performance of the Li—S pouch cell.

The present invention has as one goal, providing efficient strategies to address the above-mentioned issues that arise for Li—S batteries with carbonate-based electrolytes in order to provide a new battery system comprising a cathode with a high sulfur loading as well as a more stable Li-metal anode with improved energy density. A nitrogen-containing conductive polymer-sulfur composite has been synthesized under pressure exerted by solvent and sulfide molecules in a closed system in which sulfur is chemically linked and confined into the nitrogen-containing polymer such that short sulfur chains are immobilized in the conductive polymer. This reduces or avoids the formation of soluble polysulfides during battery cycling.

The lithium anodes made by the present method may be used with a variety of cathodes including, but not limited to cathodes comprising sulfur, graphite, sulfurized carbon; polyanionic cathodes, such as lithium iron phosphate (LiFePO₄ or LFP), lithium manganese phosphate (LiMnPO₄); spinel-type cathodes, such as LiMn₂O₄ (LMO), lithium nickel manganese spinel (LNMO); layered type cathodes, such as lithium cobalt oxide (LiCoO₂), lithium nickel cobalt manganese oxide (NMC); metal oxides, such as vanadium oxide (V₂O₅), manganese oxide (MnO₂), copper oxide (CuO) and electrically conductive polymers. Some metal oxide cathodes may be considered polyanionic cathodes, spinel-type cathodes, and layered type cathodes as well.

The present method provides the flexibility to permit tuning of the sulfur loading and particle size [e.g. control of tap density] in the composite, which are both important for electrochemical performance. The composite is synthesized in a closed system [e.g. an alumina boat closed with an alumina plate] by mixing 1.0 wt. % to about 2.0 wt. % of a nitrogen containing polymer and 1.0 wt. % to about 6.0 wt. % of sulfur followed by heating to a temperature of from 250° C. to 400° C. for 2-8 hours in inert atmosphere. Sulfurized polyacrylonitrile (SPAN) synthesized in the closed system was capable of providing a sulfur loading of about 53.6 wt. %, whereas SPAN synthesized in an open system only achieved a sulfur loading of 45.3 wt. % with an initial capacity of 625 mAh/g at a 0.5 C rate. Pouch cells were prepared having these high sulfur loadings with SPAN as the cathode.

A primary focus of the present invention is stabilizing the lithium metal in a stepwise manner for use with a carbonate electrolyte. There is a need for a strongly adhered, conformal coating of a polymeric support to immobilize the LiF to help maintain good connectivity between LiF particles and which remains stable even at high current density. Fluorinated polymer i.e, poly(vinylidenefluoride-co-hexafluoropropylene) (PVDF-HFP) is a good option for the composite layer on the Li-metal surface to achieve the desired structure. PVDF-HFP along with the Li-salt is used as the gel electrolyte due to its chemical and electrochemical stability and good ionic conductivity. Moreover, HFP contributes to partial amorphization that improves the Li-ion conductivity and the elastic moduli of PVDF-HFP supports the volume change of lithium during plating and stripping²⁷. However, PVDF-HFP lacks the essential mechanical strength required for this application due to absence of an inorganic component.

The present invention involves in situ LiF coating along with a polymeric support by a solid/liquid/solid conversion of PVDF-HFP which results in a uniform mix of inorganic LiF and the organic component (partially defluorinated PVDF-HFP) that supports the uniform Li-flux and volume change of lithium during plating and stripping. The solid polymer film of PVDF-HFP is coated on Li-metal by applying external pressure followed by dissolving with a suitable solvent such as dimethyl formamide (DMF) preferably with a ratio of PVDF-HFP:DMF of about 1:1, and then air dried. This method of solid-liquid-solid conversion results in formation of LiF embedded in the partially defluorinated polymeric support. In this manner, the percentage of LiF in the support and the defluorinated polymer formation can be controlled by adjusting the ratio of PVDF-HFP:DMF.

Additionally, the present application compares a solid PVDF-HFP film to a PVDF-DMF coating on the Li-metal. Roll pressing is used for all the coatings. The stability of the Li-metal with the two different coatings was tested by fabricating pouch cells comprising SPAN as the cathode. In each pouch cell there is a Li-metal anode having a LiF coating derived from PVDF-HFP:DMF , PVDF:DMF and PVDF-HFP. The pouch cell with the PVDF-HFP:DMF coating had an initial capacity of 670 mAh/g, while the pouch cells with the PVDF-HFP and the PVDF:DMF coatings had initial discharge capacities of 660 mAh/g and 675 mAh/g, respectively. The cycle life performance of the pouch cell having Li-metal coated with PVDF-HFP:DMF was enhanced compared to the pouch cells that employed the other two coatings. This improvement is attributed to the uniform LiF distribution within polymeric support which improves the Li ionic conductivity and the volume change.

The anodes of the present invention have an artificial SEI applied onto the Li-metal surface of ultra-conformal polymeric coatings applied using physical treatments. The method of conformally coating the fluorinated polymers may include the application of pressure on the lithium metal by roll pressing. This method can be used to form Li-metal anodes having varying thicknesses of about 1 μm-100 μm, or from about 2 μm to about 75 μm, or from about 3 μm to about 50 μm.

The conformality of the fluorinated polymeric coating on the Li-metal surface may be tuned by tuning the distance between the rollers of the roll press. Fluorinated polymer film may be formed from a fluorinated polymer solution which can be prepared by mixing the fluorinated polymer into a non-aqueous solvent, for example, acetone and/or dimethyl formamide, in varying weight percentages.

The fluorinated polymer solution may be cast as a film on a glass slide using a doctor blade, where the thickness of the film can be controlled by changing the doctor blade thickness. The solvent is then evaporated at room temperature leaving the film. Once the film has been formed, it can be easily removed from the substrate.

The film is placed onto the lithium metal surface and subjected to an additional step of roll pressing to provide the conformal coating of the solid fluorinated polymeric film onto the Li-metal. To further improve the chemical and physical connectivity of the polymeric film with the lithium metal, the solid fluorinated polymer coated on the lithium metal is transformed to the liquid phase by surface treatment of the fluorinated polymer coated lithium with a suitable solvent such as DMF, acetone etc., and the coating is then dried at room temperature to reform a solid conformal layer. The Li-metal coated using the solid-liquid-solid phase coating method remained stable for more than 200 cycles.

### EXAMPLES

### Materials

The following materials were used to prepare the SPAN-polyacrylonitrile (M_{w}=150,000 g mol⁻¹, purchased from Sigma Aldrich), sulfur (99.5%, sublimed, catalog no. AC201250025), and ethanol (Sigma Aldrich, 99%).

Materials for making the SPAN electrode-ϵarbon black—Super P™ (Alfa aesar), Sodium carboxy methyl cellulose (Alfa Aesar), and styrene butadiene rubber (MTI corporation).

Materials for stabilizing the Li-metal—polyvinylidene fluoride (Aldrich chemistry), polyvinylidene fluoride-hexafluoro propylene (Aldrich chemistry), dimethyl formamide (Fisher chemicals), and acetone.

Materials for electrochemistry—1M lithium hexafluorophosphate in ethylene carbonate (EC) and diethyl carbonate (DEC) [1:1] (LiPF₆ in EC:DEC—Aldrich), and fluoroethylene carbonate (FEC) (Alfa Aesar).

### SPAN Synthesis

SPAN was synthesized by mixing polyacrylonitrile (PAN) and sulfur at 1:4 weight ratio by wet ball milling for 12 hours at 400 rpm using ethanol as the solvent. The mixture was then dried at 50° C. in vacuum oven for 6 hours and subsequently heat treated in a tubular furnace [Nabertherm] at 350° C. for 4 hours under nitrogen flow to obtain the SPAN [sulfurized carbon]. For the open synthesis method, the PAN/S mixture was held in an open ceramic boat, while for the closed synthesis method, the PAN/S mixture was placed in an alumina ceramic boat closed by an alumina plate followed by wrapping with aluminum foil. For doped SPAN, 2 wt. % of cobalt chloride (Acros organics) was added to the PAN/S mixture followed by wet ball milling. The cobalt doped samples were synthesized in both the closed and open systems.

Lithium Treatment—Preparation of a 4 wt/Vol % PVDF-DMF Solution and Artificial SEI on Li-Metal

This example was carried out using a liquid-solid conversion method. 400 mg of PVDF was dissolved in 10 ml of the DMF and stirred for 12 hours to make a homogeneous solution having 4 wt/vol % of PVDF/DMF. For the PVDF film, a wet polypropylene separator soaked in the 4 wt/vol % PVDF/DMF solution was placed on the lithium metal surface followed by roll pressing at 0.328 rpm resulting in solid LiF and a completely de-fluorinated polymer coating.

Lithium Treatment—Preparation of a 4 wt/Vol % PVDF-HFP-Acetone Solution and Artificial SEI on Li-Metal—

This example was carried out using a solid-liquid-solid method. 400 mg of PVDF-HFP was dissolved in 10 ml of acetone and stirred for 12 hours to make a homogeneous solution having 4 wt/vol % of PVDF/Acetone. For the PVDF-HFP treatment, first a PVDF-HFP film was made by coating a PVDF-HFP solution on a glass plate using a doctor blade. The coating was dried for 5 minutes leaving behind a solid film that was easily peeled off. The thickness of the film was in the range of 8-10 micrometers. The peeled off solid film was placed on the lithium metal surface followed by roll pressing at 0.328 rpm. Then, a polypropylene separator soaked with DMF solvent was placed on the PVDF-HFP coated lithium metal followed by roll pressing. This process resulted in partial re-dissolution of the solid PVDF-HFP polymer in DMF on the Li and facilitated improved interaction between the Li and the PVDF-HFP. The excess DMF evaporated in a few minutes and left behind a solid film between the Li and separator.

### Material Characterizations—SEM/EDS, FTIR, XPS, Elemental Analysis, DLS.

Morphological analysis of the materials was conducted using an SEM (Zeiss Supra 50VP, Germany) with an in-lens detector. A 30-mm aperture was used to examine the morphology and to obtain micrographs of the samples. To analyze the surface elemental composition, Energy Dispersive Spectroscopy (EDS) (Oxford Instruments) in secondary electron-detection mode was used. The surface of the composites was analyzed with X-ray photoelectron spectroscopy (XPS). To collect the XPS spectra, Al-Ka X-rays, with spot sizes of 200 mm and a pass energy of 23.5 eV were used to irradiate the sample surface. The Al-Ka X-rays use an aluminum element as its source and the X-rays are produced due to the transition of electrons between the core energy levels, i.e. the fall of electrons from the L-shell to the K-shell. A step size of 0.05 eV was used to gather the high-resolution spectra. CasaXPS™ (version 23.19PR1.0) software was used for spectra analyses. The XPS spectra were calibrated by setting the valence edge to zero, which was calculated by fitting the valence edge with a step-down function and setting the intersection to 0 eV. The background was determined using the Shirley algorithm, which is a built-in function in the CasaXPS™ software. The infrared spectra of the samples were collected using a Fourier transform infrared (FTIR) spectrometer (Nicolet iS50, Thermo-Fisher Scientific) using an extended range diamond Attenuated Total Reflection (ATR) accessory. A deuterated triglycine sulfate (DTGS) with a resolution of 64 scans per spectrum at 8 cm-1 was used and all the spectra were further corrected with background, baseline correction and advanced ATR correction in the Thermo Scientific Omnic™ software package.

### Electrode Formation

Initially 80 wt. % of SPAN and 10 wt. % carbon black super P™ were mixed in a Flacktek™ speed mixer for 5 minutes. Homogenous 4 volume percent sodium carboxymethylcellulose-styrene-butadiene rubber (NaCMC-SBR) binder was made in another vial using water as the solvent in the Flacktek™ speed mixer. Then, the SPAN-carbon black mixture was added to the binder solution in an amount to make up 10 wt. % of the complete electrode slurry and speed mixed for 1 hour at 2500 rpm with a 5-minute gap between each cycle. The resultant electrode slurry was coated onto the carbon coated aluminum foil using an applicator with a thickness of 250 micrometer followed by drying in oven at 50° C.

### Coin-Cell Fabrication

The dried electrodes were cut using a hole punch (f=0.5 inch [12.7 mm]) to form disk-sized electrodes. The electrodes were then weighed and transferred to an argon-filled glove box (MBraun LABstar, 02<1 ppm and H₂O<1 ppm). The CR2032 (MTI and Xiamen TMAX Battery Equipments, China) coin-type Li—S cells were assembled using SPAN (f=12 mm), lithium disk anodes (Xiamen TMAX Battery Equipment's; f=15.6 mm, 450 mm thick), a tri-layer separator (Celgard 2325; f=19 mm), one stainless-steel spring, and two spacers, along with an electrolyte. The electrolyte with 1M LiPF₆ in ethylene carbonate:diethyl carbonate (EC:DEC) at a 1:1 volume ratio was purchased from Aldrich chemistry, with H₂O<6 ppm and O₂<1 ppm. The assembled coin cells were rested at their open-circuit potential for 12 hours to equilibrate them before performing electrochemical experiments at room temperature. Cyclic voltammetry was performed at various scan rates (0.5 mV/s) between voltages of 1 V and 3 V with respect to Li/Li+ with a potentiostat (Biologic VMP3). Prolonged cycling stability tests were carried out with a Neware BTS 4000 battery cycler at different C-rates (where 1 C=650 mAhg⁻¹) between voltages of 1.0 V and 3.0 V.

### Pouch Cell Fabrication

Cathodes were punched with dimensions of 57 mm×44 mm using a die cutter MSK-T-11 (MTI, USA). A 4-inch (101.6 mm) length lithium strip (750 μm thick, Alfa Aesar) was rolled by placing it between aluminum-laminated film to provide a 60 mm×50 mm Li sheet using an electric hot-rolling press (TMAX-JS) at 0.328 rpm inside the glove box (MBraun, LABstar Pro). Once the final dimensions of the lithium sheet were achieved (400 μm-500 μm thick—by adjusting the distance between the rollers of the roll press), it was re-rolled with a copper current collector (10 mm) to achieve good adhesion. Finally, the lithium-rolled copper sheet was punched with a 58-mm×45-mm die cutter (MST-T-11) inside the glove box. The cathode and anode were welded with aluminum and nickel tabs (3 mm), respectively. The tabs were welded with an 800-W ultrasonic metal welder, using a 40 KHz frequency; a delay time of 0.2 seconds, welding times of 0.15 second and 0.45 section for Al|Al and Cu|Ni, respectively; and a cooling time of 0.2 second with a 70% amplitude. The anode and cathode were placed between a Celgard 2325 separator, and the pouch was sealed with 3-in-1 heat pouch sealer inside the glove box with a 95 kPa vacuum, 4 second sealing time at 180 C and a 6-second degas time.

Table 1 shows the elemental analysis in weight percentages of the elements of the carbonized PAN, SPAN synthesized in a closed system (w/Co doping), and SPAN synthesized in an open system, wherein the closed system synthesis was carried out with ethanol wetting and the open system synthesis was carried out without ethanol wetting.

TABLE 1

| Wt. % | % N | % C | % S |
|---|---|---|---|
| PAN | 22.24 | 62.73 | 0 |
| SPAN [Open] | 14.66 | 33.80 | 45.30 |
| SPAN [closed system w/Cobalt doped] | 13.28 | 31.91 | 53.62 |

Elemental analysis shows that the percentage of sulfur was zero in the PAN which was carbonized at 350° C. under the flow of nitrogen. In contrast, the percentage of sulfur was 53.62% in the SPAN synthesized in the closed system, which is higher than the sulfur percentage of the SPAN synthesized in the open system (45.30%).

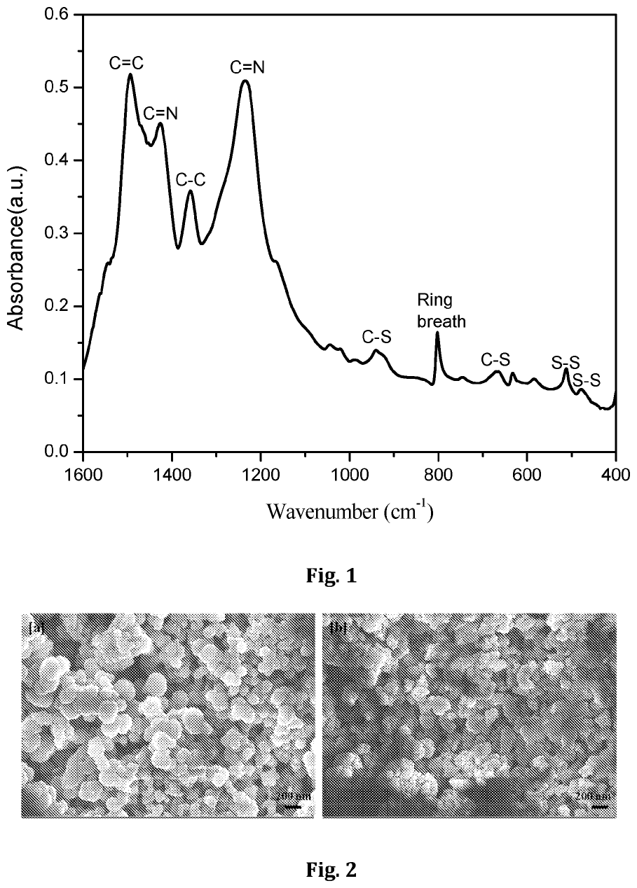

In FIG. 1, the peaks at 477 cm⁻¹ and 511 cm⁻¹ correspond to S—S stretching¹ and the peaks at 668 cm⁻¹ and 936 cm⁻¹ were assigned to C—S stretching.^{2,3} The peak at 803 cm⁻¹ indicates the formation of a hexahydric ring. 12 The peaks at 1495 cm⁻¹ and 1359 cm⁻¹ were assigned to the C—C¹³ and C—C deformation, respectively, and the peaks at 1427 cm⁻¹ and 1235 cm 1 correspond to C═N stretch.¹⁴ In brief, the signals of C—C, C═C, and C═N confirm the comprehensive sulfur-assisted dehydrogenation, cyclization, and aromatization of the aliphatic PAN to a polyaromatic system.

Comparison of Particle Size and Morphology Between the Composites Synthesized in Closed System with and without Ethanol

The vapor pressure exerted by ethanol vapor affects the particle size and morphology. Composites synthesized in the closed system with ethanol wetting show many individual particles having sizes ranging from 100 nm-250 nm, as measured by a scanning electron microscope (SEM) and Dynamic Light Scattering (DLS). These particles form agglomerates (secondary particles) with sizes ranging from 400 nm-500 nm, as measured by a scanning electron microscope (SEM) and Dynamic Light Scattering. The composite synthesized in the closed system without ethanol wetting also had sulfur particle sizes ranging from 100 nm-250 nm, but the agglomerates (secondary particles) formed from the primary particles had sizes ranging from 900 nm to 1.5 micrometers. These sizes are not desirable for good electrochemical performance of a cathode active material. Large agglomerates increase the charge transfer resistance and increase the overall resistance due to close contact of the insulating sulfur particles. DLS analysis was done to further confirm the average size distribution of the agglomerates. The DLS reports indicate that the average agglomerate size of the composite synthesized in the closed system with ethanol wetting was about 500 nm and without ethanol wetting was about 900 nm.

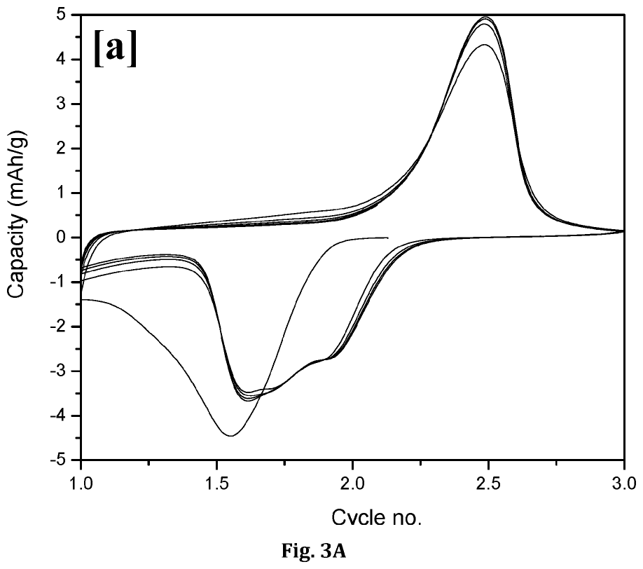

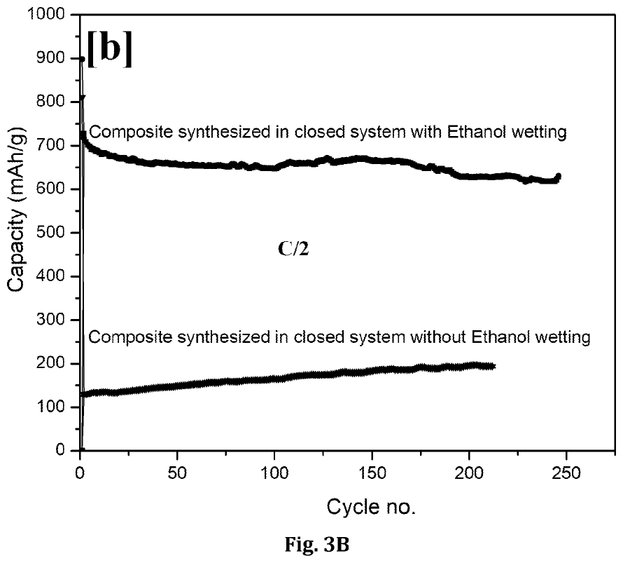

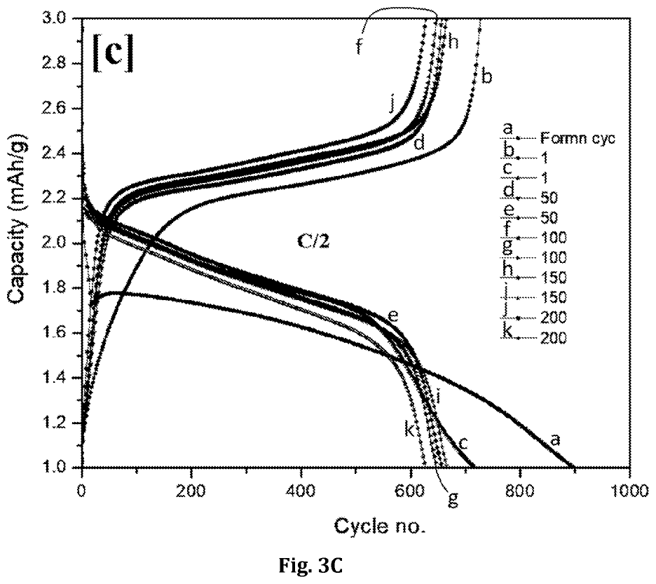

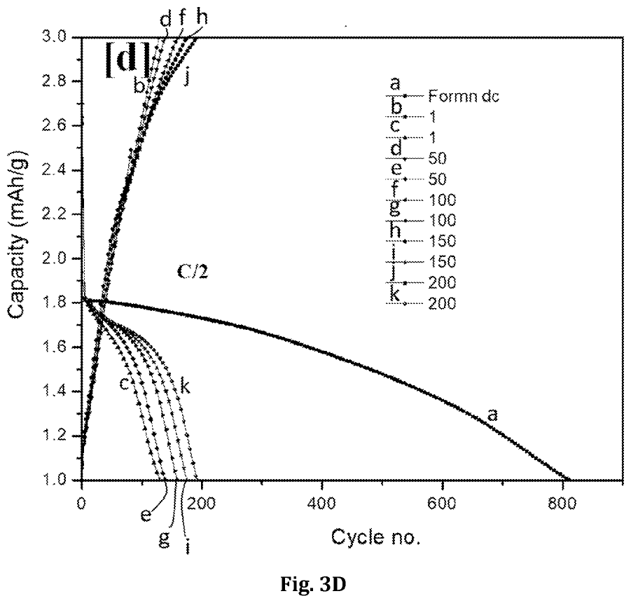

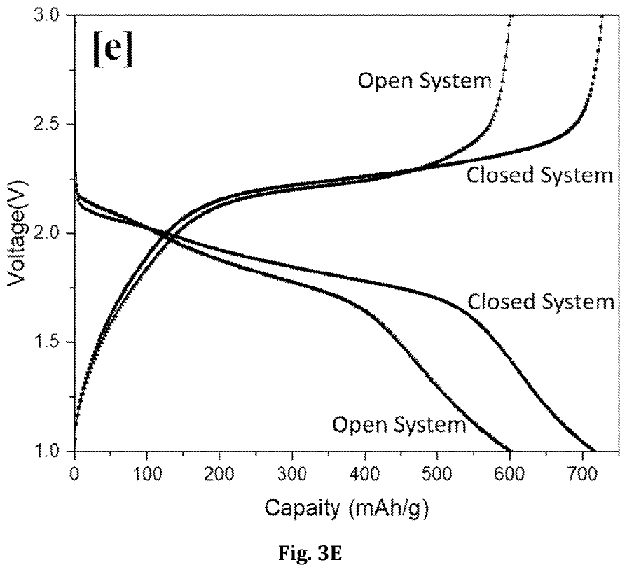

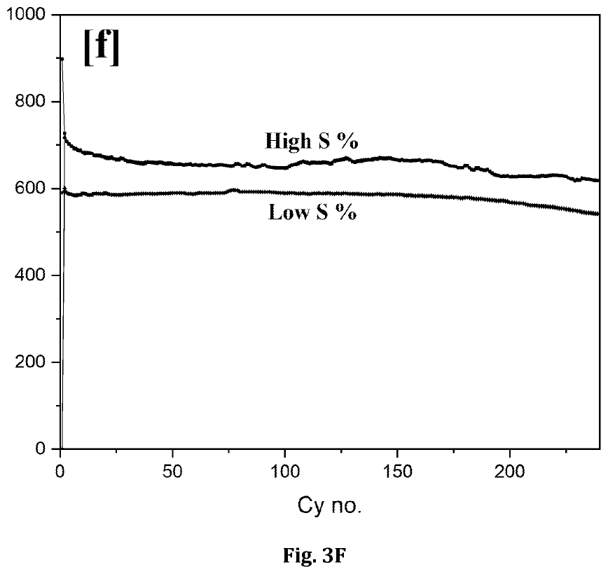

The electrochemical behavior of the SPAN cathode|LiPF₆ electrolyte|Li-anode cell was characterized by using cyclic voltammetry (shown in FIG. 3A). Cyclic voltammetry (CV) was tested within the voltage range of 1 V and 3 V at 0.2 mV/s. The initial cathodic peak at 1.55 V was ascribed to the solid electrolyte interphase formation on the cathode surface and activation of the bonded sulfur chains. During initial discharge there was cleavage of S—S bonds adjacent to carbon rings that required more energy input. The peaks at voltages below 2.1V correspond to S—S bond breakage⁴² FIG. 3B shows the capacity vs cycle number of the composites synthesized in the closed system with and without ethanol wetting. Composite with ethanol wetting showed initial and final capacities of 721 mAh/g and 630 mAh/g [240^{th} cycle] at a C/2 rate, whereas the composite without ethanol wetting exhibited a poor initial capacity of 131 mAh/g that increased to 192 mAh/g at the 210^{th} cycle. The composite synthesized conventionally showed an initial capacity of 625 mAh/g at C/2 with a capacity retention of 84% and the composite synthesized in the closed system with ethanol wetting showed an improved initial capacity of 723 mAh/g with a capacity retention of 91% (see FIG. 3B).

FIGS. 3C and 3D show the voltage profiles of composites synthesized with and without ethanol wetting. The composite synthesized with ethanol wetting showed an initial formation discharge cycle with a capacity of 900 mAh/g followed by a reversible discharge capacity of 721 mAh/g. There was an irreversible capacity of 180 mAh/g between the formation cycle and consequent discharge cycle having an initial coulombic efficiency of 80 percent. The initial capacity loss was attributed to cathode electrolyte interphase formation on the cathode due to reaction of the electrolyte with the surface sulfur. This was confirmed by cyclic voltammetry.⁴³ FIG. 3C shows that the voltage plateau during the initial discharge cycle (˜1.8 V) was lower than the values observed in subsequent cycles. There was a flat discharge plateau starting from 2.2 V up to 1.6 V in which range, 90% of the capacity that contributes to the improved energy density was attained.

FIG. 3D shows the voltage profile of SPAN synthesized in the closed system without ethanol wetting. FIG. 3D shows an initial formation cycle capacity of 810 mAh/g followed by a drastic decrease in subsequent cycles showing the poor electrochemistry with an initial columbic efficiency of 16%. The charge and discharge profiles were not flat and looked similar to capacitive behavior i.e., a straight line. The poor electrochemistry may be attributed to the large sulfur agglomerate size which increased the resistance for ion and electron transfer contributing to capacitive behavior. There was good initial formation discharge capacity, but due to the bulk size (900 nm) of the agglomerates, the attained reversible capacity contribution was only from the surface of the agglomerates, thus resulting in the poor electrochemical performance. Another possible reason may be the irreversible volume change during initial formation discharge where most of the active material pulverized and lost the electrical contact. This phenomenon is common in an active electrode with bulk size.

The composite synthesized in the closed system with ethanol wetting outperformed the other composites in cycle life and capacity retention. The improvement in the electrochemical performance was attributed to the moderate/optimum particle and agglomerate sizes resulting in low resistance for the transfer of ions and electrons from the surface to the bulk. Moreover, the insulating sulfur accumulation was less compared to larger agglomerates thus reducing the overall impedance. Due to its moderate size, there was volume change accommodation without pulverization resulted in a compact electrode without a loss of electrical contact.

FIG. 3E shows a comparison of the voltage profile of the SPAN cathode synthesized in the closed system with ethanol wetting and in the open system without ethanol wetting. Both cathodes showed similar voltage profiles irrespective of sulfur percentage. SPAN synthesized in the open system without ethanol wetting showed an initial discharge capacity (formation cycle) of 769 mAh/g and the discharge capacities of other subsequent cycles ranged from 620 mAh/g (2^{nd} cycle)-550 mAh/g (90^{th} cycle) which were lower than SPAN synthesized in the closed system with ethanol wetting. This suggests that there was an increase in the sulfur percentage of SPAN synthesized in the closed system with ethanol wetting since SPAN synthesized in the open system with and without ethanol wetting showed less capacity which was attributed to low sulfur percentage. A closed system helps in the accumulation of extra sulfur in the composite due to the pressure developed by the ethanol vapor and H₂S gas generated during the synthesis. Also, there is an increase in sulfur percentage in the closed system without ethanol wetting due to pressure developed by sulfide gas generated during synthesis. The absence of ethanol leaded to the agglomeration of the particles as evidenced by SEM. This suggested that when the ethanol solvent evaporated it left behind gaps between the particles thus preventing the agglomeration during the synthesis.

### Anode

### Potential Mechanism of LiF Formation

Jialiang Lang et al. dissolved PVDF in DMF solution and coated it on Li-metal during which PVDF defluorinated and formed an LiF coating on the Li-metal.²⁸ Similarly, Jansta et al. reported the decomposition of PTFE by contacting it with Li-amalgam. These interactions generated metal fluorides and polyenes. Similarly, dissolving the PVDF-HFP layer made by roll pressing using a 4 wt. %/vol % PVDF-DMF solution allowed the interaction of liquid state PVDF-HFP with Li-metal. During this process, the external pressure applied by roll pressing activated the reaction between reactive Li-metal and dissolved polymer. This process decomposed the polymer to form LiF and partially defluorinated polyene. Most of the LiF that was formed was coated and embedded in the partially defluorinated polymer (polyene).

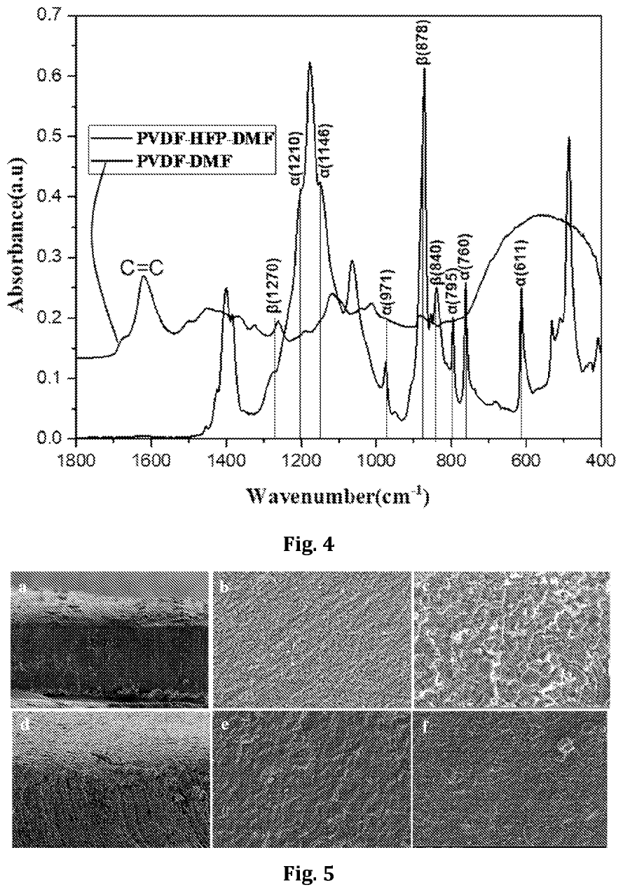

The PVDF-HFP on the Li-metal surface was analyzed by FTIR spectra and is represented in FIG. 4 The vibrational peaks observed at 611, 760, 795, 1146, 1210 cm⁻¹ were due to the α-phase of PVDF-HFP.^{29,30,31} The peaks at 1270, 840, 878 cm⁻¹ correspond to the β-phase.³² with CH₂ and CF₂ dipoles of the PVDF-HFP matrix.³³ All of the above peaks are absent in the FTIR spectrum of Li-metal surface coated with PVDF-DMF suggesting the complete defluorination of PVDF which is further evidenced by the polyene peak at about 1620 cm⁻¹.²⁸ Although there is partial defluorination of the PVDF-HFP, the absence of polyene peak is possibly due to a masking effect of the defluorinated PVDF-HFP polymer.

The morphology of PVDF-HFP-DMF and PVDF-DMF coated lithium is characterized by SEM. FIG. 5B is the SEM image of PVDF-DMF coated lithium metal before cycling and FIG. 5C is the same material after 10 cycles. FIG. 5C shows a rough surface filled with cracks and a porous structure. FIGS. 5E and 5F are the SEM images of the Li-metal coated with PVDF-HFP before and after 10 cycles, respectively. FIG. 5F shows a flat surface with some cracks but no obvious porous structure indicating that the PVDF-HFP-DMF coated film was stable both electrochemically and mechanically. Moreover, the PVDF-HFP coating minimized direct contact between the dense lithium and the electrolyte thereby substantially reducing or preventing corrosion of the lithium metal by reaction with the electrolyte.

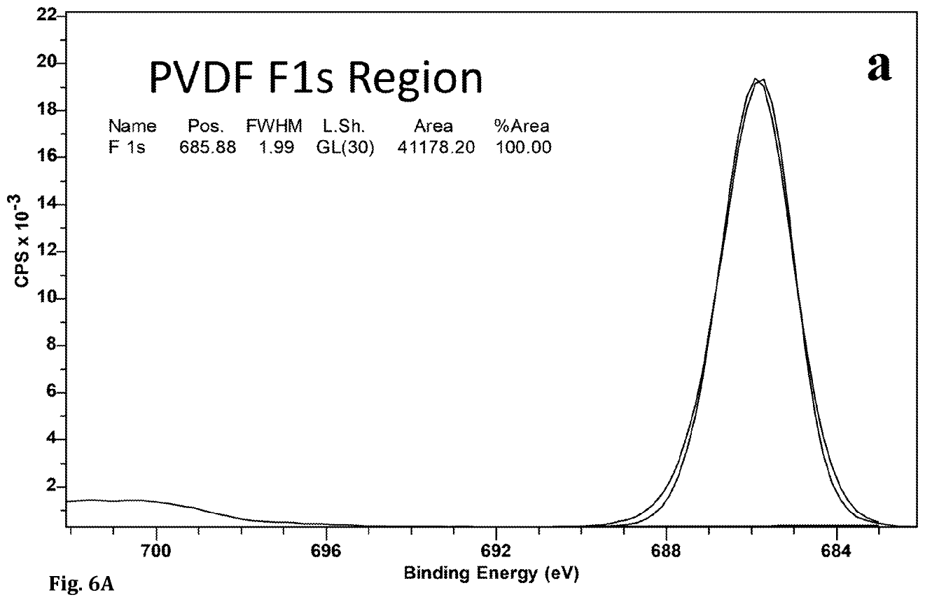

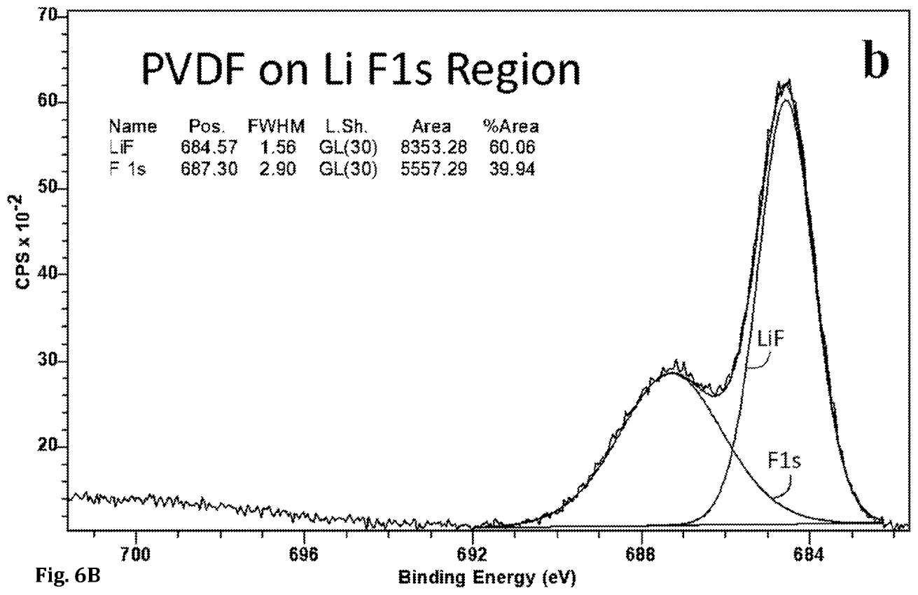

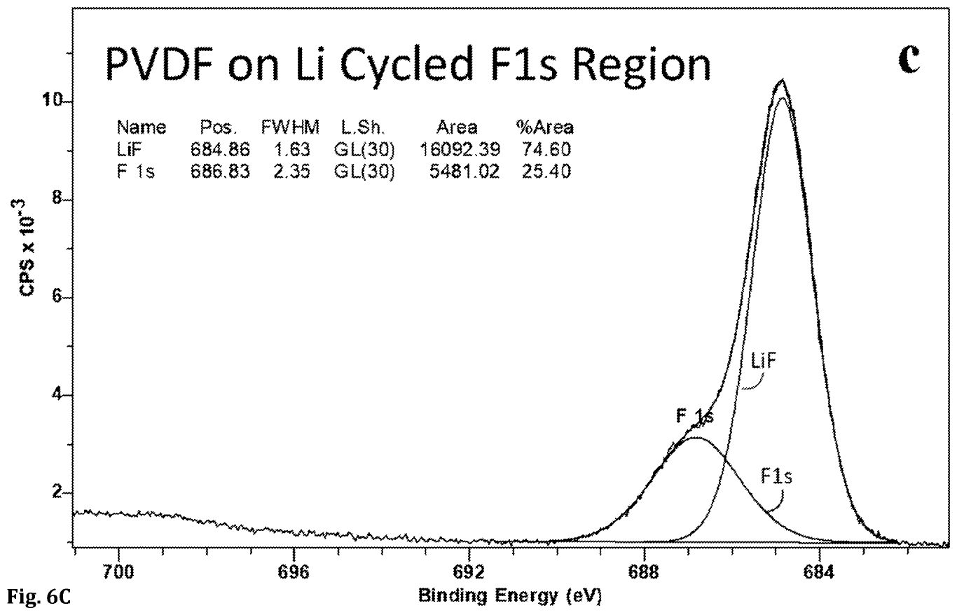

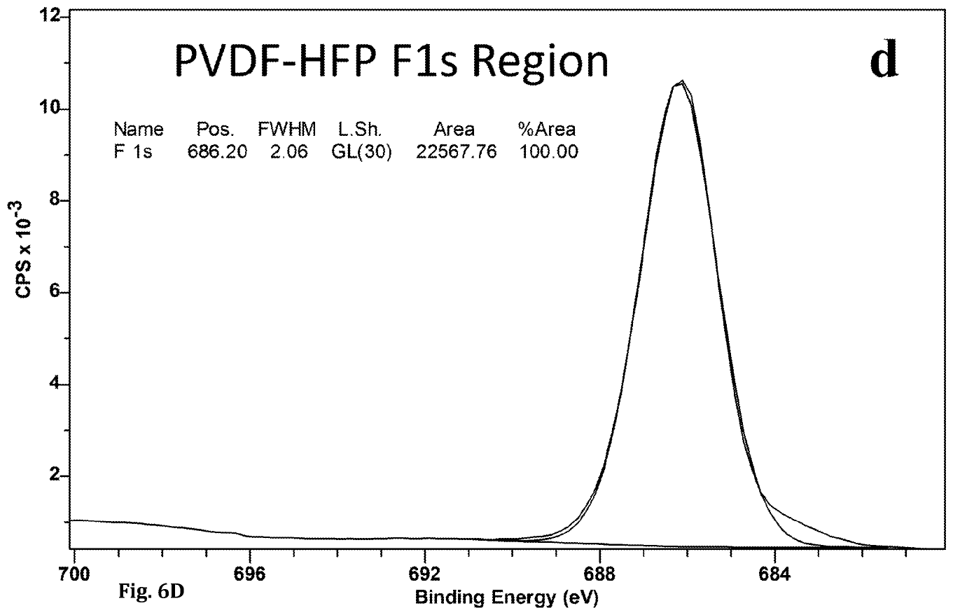

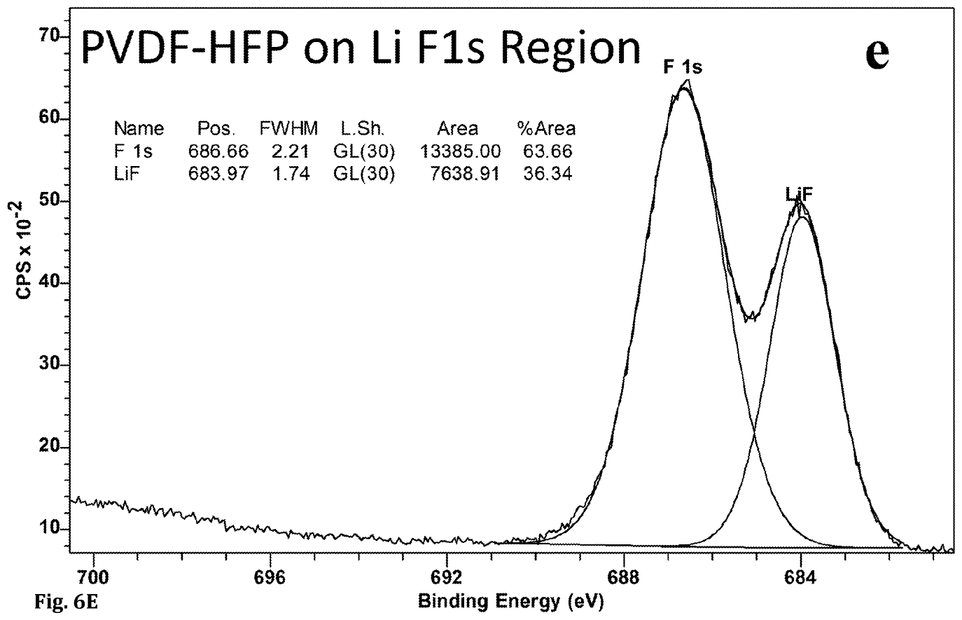

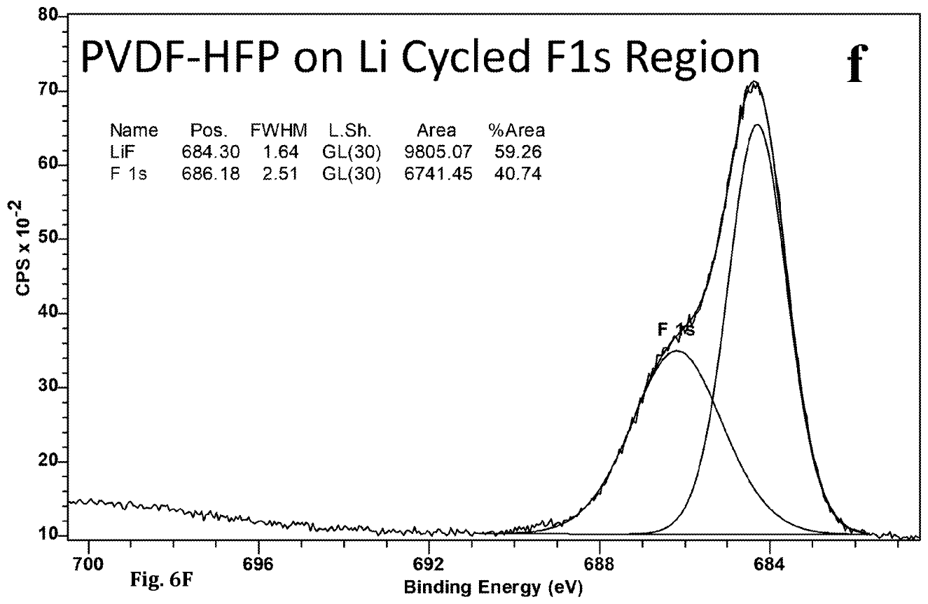

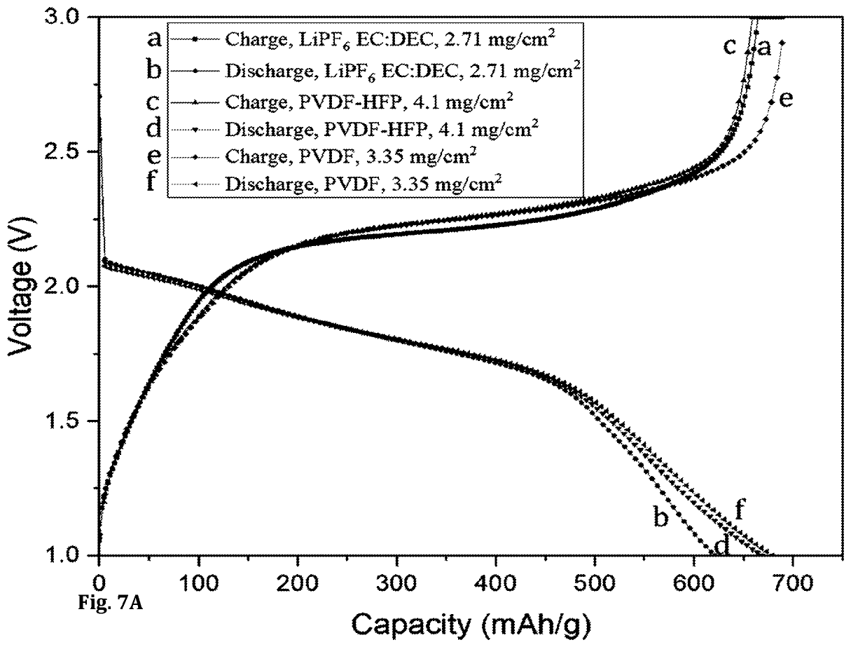

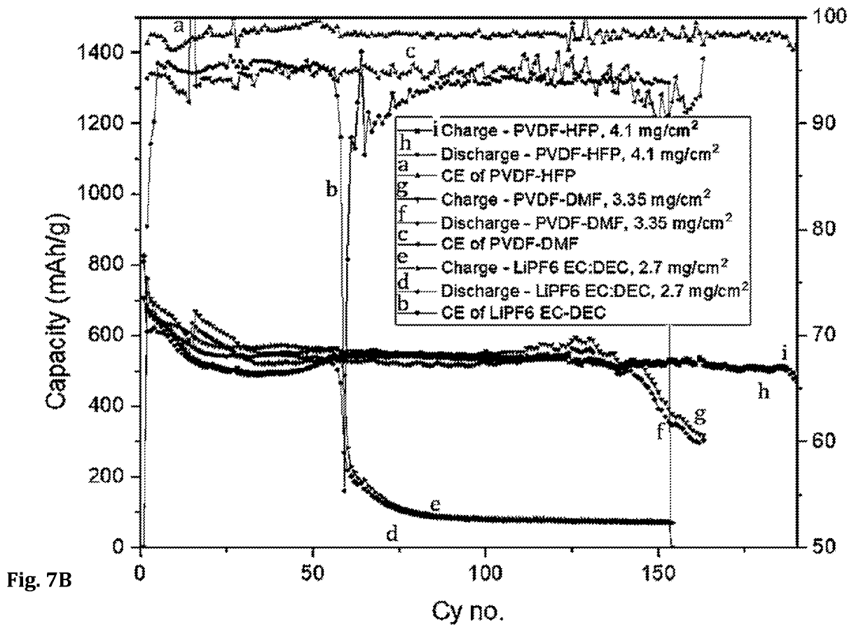

From FIGS. 6A and 6D, which are the XPS peaks corresponding to pristine PVDF and PVDF-HFP, it is evident that there were no LiF signatures observed. LiF signatures evolved when PVDF-DMF was coated onto the Li-metal by liquid to solid conversion (FIG. 6B) and when PVDF-HFP was coated onto Li-metal by solid-liquid-solid conversion. This observation suggests that there was LiF formation by the coating of the fluorinated polymers onto the lithium metal. However, the percentage of LiF formed was in excess in the case of liquid to solid conversion of PVDF-DMF coating (LiF-60.06%, C—F-39.94%) when compared to the solid-liquid-solid conversion of PVDF-HFP coating (LiF-36.34%, C—F-63.66%). The ratio of the PVDF-HFP (63.66%):LiF (36.34%) was 2:1 which is highly desirable for providing improved Li-metal stability.³⁴ Generally, for complete defluorination of the polymer, the ratio of the PVDF-HFP to DMF should be 1:10.³⁵

In the present invention a lower 1:1 weight ratio was employed to only partly defluorinate the polymer and form a uniform mixture of inorganic (LiF) and organic (partly defluorinated polymer) components. This mixture provides for stable Li-ion flux and volume change along with improved mechanical strength.

FIGS. 6C and 6F show the XPS of the cycled lithium coated with PVDF-DMF (FIG. 6C) and PVDF-HFP-DMF (FIG. 6F). There was an increase in the LiF percentage in both cases. The increase in LiF may be due to salt decomposition from the electrolyte. In the case of PVDF-HFP-DMF there was a high percentage of polymer (˜60%) that strongly supported the LiF integration and hence promoted the uniform Li-plating and stripping. It also prevented the direct contact of lithium with the electrolyte thus reduced electrolyte consumption for SEI formation in each cycle.

### Proposed Reactions

$$\begin{matrix}PVDF - DMF \\ - {[ {( C {H}_{2} - C {F}_{2} )}_{2} ]}_{n -} + 4 Li \to 4 LiF + 2 {H}_{2} + - {[ CH = C = C = CF ]}_{n -}\end{matrix} \qquad ( 1 )$$

$$\begin{matrix}PVDF - HFP : DMF \\ {- {[ {CH}_{2} - {CF}_{2} ]}_{n} - {[ {CF}_{2} - CF ( {CF}_{3} ) ]}_{m -} + Li \to LiF + {H}_{2} + - {[ CH = CF ]}_{x} {[ {CH}_{2} - {CF}_{2} ]}_{n - x} - {CF}_{2} - CF ( {CF}_{3} ) ]}_{m}\end{matrix} \qquad ( 2 )$$

From the FTIR it was confirmed that there was complete defluorination of the PVDF resulting in LiF and polyene. Whereas the FTIR spectrum of PVDF-HFP showed signature peaks of all of the phases of PVDF. Equation-1 is proposed based on the FTIR spectrum of PVDF showing the defluorination and formation of polyene and LiF. There was complete defluorination in the case of PVDF due to the high weight percentage of DMF giving rise to defluorinated polyene while PVDF-HFP showed only partial defluorination retaining its polymeric nature which imparted the required elastic moduli for suppressing the volume change of lithium while the LiF coating maintained the uniform flux.

### Electrochemical Performance

To evaluate the influence of the Li protection layer (LiF-polyene) on the electrochemical properties of the fuel cell, the LiF-partly defluorinated polymer-Li-metal derived from PVDF-HFP-DMF, PVDF-HFP and bare Li anodes were each paired with a SPAN cathode (Theoretical capacity-650 mAh/g). The thickness of the lithium used against the SPAN cathode in all of the pouch cells was 500 μm. SPAN showed robust cycling due to the absence of polysulfide shuttling in carbonate electrolytes. Therefore, it was possible to analyze the effects of Li-metal protection on the electrochemistry of the pouch cell by minimizing the influence of the cathode.

A pouch cell having lithium coated with PVDF-DMF showed an initial capacity of 675 mAh/g at rate of 0.5 C (areal capacity. SPAN cathode loading was 3.35 mg/cm²). The capacity initially dropped to 560 mAh/g after which, it showed stable cycling until 130 cycles after which there was a sudden fall in the capacity leading to the failure of the cell. The final capacity at the 160^{th} cycle was 260 mAh/g. The reason for the capacity fade was the formation of dead lithium during cycling which consumed the electrolyte, pulverized the anode, and resulted in capacity fade.

From this result, it appeared that LiF coating derived from PVDF-DMF may stabilize the Li-metal up to 130 cycles with a SPAN cathode having a loading of 3.35 mg/cm². The coulombic efficiency was maintained around 85-90% throughout the cycling thus suggesting the absence of stable LiF supported by polymer. Similarly, the pouch cell with commercial electrolyte (1M LiPF₆ in EC:DEC) showed poor electrochemical performance showing that carbonate electrolytes cannot support the Li-metal stability. The pouch cell employing the lithium coated with PVDF-HFP-DMF showed an initial capacity of 670 mAh/g and a capacity fade to 500 mAh/g at the 28^{th} cycle after which there was an increase in the capacity up to 550 mAh/g and thereafter the capacity stabilized. The initial capacity fade could be due to an increase in internal impedance arising from the dense LiF coating. The coulombic efficiency was above 92% throughout cycling. The pouch cell with Li-PVDF-HFP-DMF outperformed the other composites in terms of cycle life and coulombic efficiency and it showed the stable capacity of 550-560 mAh/g at 0.5C rate for 200 cycles with a SPAN loading of 4.13 mg/cm² (areal capacity).

Sustainable artificial SEI i.e., LiF mechanically supported by the polymer, was coated onto lithium metal by roll pressing. Among different fluorinated polymers employed, PVDF-HFP-DMF coated onto Li-metal following the solid-liquid-solid method described above, with the use of the roll press resulted in an efficient artificial SEI with uniform distribution of the LiF in the defluorinated polymer. This artificial SEI showed improved electrochemical performance in terms of capacity (initial capacity: 670 mAh/g, 194^{th} cycle capacity: 550 mAh/g), capacity retention, coulombic efficiency with a high loading of 4.13 mg/cm².

The XPS of lithium metal coated with PVDF-HFP:DMF (1:1) suggested the formation of an optimal percentage of LiF and partly de-fluorinated polymer which stabilized the lithium metal compared to the other polymer coatings.

Other embodiments of the present disclosure will be apparent to those skilled in the art from consideration of the specification and practice of the embodiments disclosed herein. As used throughout the specification and claims, “a” and/or “an” and/or “the” may refer to one or more than one. Unless otherwise indicated, all numbers expressing quantities, proportions, percentages, or other numerical values are to be understood as being modified in all instances by the term “about.” Accordingly, unless indicated to the contrary, the numerical parameters set forth in the specification and claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1-4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

### REFERENCES

All references cited herein are hereby incorporated by reference in their entirety as if fully set forth herein.
1. Chunmei Li, Heng Zhang, Laida Otaegui, Gurpreet Singh, Michel Armand, Lide M. Rodriguez-Martinez, Estimation of energy density of Li—S batteries with liquid and solid electrolytes, Journal of Power Sources 326 (2016) 1-5
2. JIANLIN LI et al., Toward Low-Cost, High-Energy Density, and High-Power Density Lithium-Ion Batteries, JOM 69, 1484-1496 (2017).
3. Hagen, M.; Hanselmann, D.; Ahlbrecht, K.; Maca, R.; Gerber, D.; Tübke, J. Lithium-Sulfur Cells: The Gap between the State-of-the Art and the Requirements for High Energy Battery Cells. Adv. Energy Mater. 2015, 5, 1401986
4. Su, L.; Ferrandon, M.; Barton, J. L.; de la Rosa, N. U.; Vaughey, J. T.; Brushett, F. R. An investigation of 2,5-di-tertbutyl-1,4-bis-(methoxyethoxy)benzene in ether-based electrolytes. Electrochim. Acta 2017, 246, 251-258
5. Doughty, D. H. et al. Effects of additives on thermal stability of Li ion cells. J. Power Sources 146, 116-120 (2005).
6. Zhang, S. S. A review on electrolyte additives for lithium-ion batteries. J. Power Sources 162, 1379-1394 (2006).
7. Xia Li, Mohammad Banis, Andrew Lushington, Xiaofei Yang, Qian Sun, Yang Zhao, Changqi Liu, Qizheng Li, Biqiong Wang, Wei Xiao, Changhong Wang, Minsi Li, Jianwen Liang, Ruying Li, Yongfeng Hu, Lyudmila Goncharova, Huamin Zhang, Tsun-Kong Sham & Xueliang Sun A high-energy sulfur cathode in carbonate electrolyte by eliminating polysulfides via solid-phase lithium-sulfur transformation. Nat Commun 9, 4509 (2018).
8. Pai, R., Singh, A., Tang, M. H. et al. Stabilization of gamma sulfur at room temperature to enable the use of carbonate electrolyte in Li—S batteries. Commun Chem 5, 17 (2022).
9. Jianhua Yan1, Xingbo Liu, Xianfeng Wang and Bingyun Li, Long-Life, High-Efficiency Lithium/Sulfur Batteries from Sulfurized Carbon Nanotube Cathodes, Journal of Materials Chemistry A, 2013, 00, 1-3.
10. Zheng, S., Han, P., Han, Z. et al. High Performance C/S Composite Cathodes with Conventional Carbonate-Based Electrolytes in Li—S Battery. Sci Rep 4, 4842 (2014).
11. Cheng, X. B.; Zhang, R.; Zhao, C. Z.; Zhang, Q. Toward Safe Lithium Metal Anode in Rechargeable Batteries: A Review. Chem. Rev. 2017, 117, 10403-10473.
12.) Lin, D.; Liu, Y.; Cui, Y. Reviving the lithium metal anode for high-energy batteries. Nat. Nanotechnol. 2017, 12, 194-206.
13. J. Steiger, D. Kramer, R. Monig, “Mechanisms of dendritic growth investigated by in situ light microscopy during electrodeposition and dissolution of lithium, J. Power Sources 261 (2014) 112-119.
14. A. Hagopian, M.-L. Doublet, J.-S. Filhol, Thermodynamic origin of dendrite growth in metal anode batteries, Energy Environ. Sci. 13 (2020) 5186-5197.
15. X.-B. Cheng, C. Yan, J.-Q. Huang, P. Li, L. Zhu, L. Zhao, Y. Zhang, W. Zhu, S.-T. Yang, Q. Zhang, The gap between long lifespan Li—S coin and pouch cells: the importance of lithium metal anode protection, Energy Storage Mater. 6 (2017) 18-25.
16. Xiaodi Ren1, Lianfeng Zou, Shuhong Jiao, Donghai Mei, Mark H. Engelhard, Qiuyan Li, Hongkyung Lee, Chaojiang Niu, Brian D. Adams, Chongmin Wang, Jun Liu, Ji-Guang Zhang1, Wu Xu, High Concentration Ether Electrolytes for Stable High-Voltage Lithium Metal Batteries, ACS Energy Lett. 2019, 4, 4, 896-902.
17. Teklay Mezgebe Hagos, Tesfaye Teka Hagos, Hailemariam Kassa Bezabh, Gebregziabher Brhane Berhe, Ljalem Hadush Abrha, Shuo-Feng Chiu, Chen-Jui Huang, Wei-Nien Su, Hongjie Dai and Bing Joe Hwang, Resolving the Phase Instability of a Fluorinated Ether, Carbonate-Based Electrolyte for the Safe Operation of an Anode-Free Lithium Metal Battery, ACS Appl. Energy Mater. 2020, 3, 11, 10722-10733.
18. H. Zhang, G. G. Eshetu, X. Judez, C. Li, L. M. Rodriguez-Martinez, M. Armand, Electrolyte additives for lithium metal anodes and rechargeable lithium metal batteries: progress and perspectives, Angew. Chem. Int. Ed. 57 (2018) 15002-15027.
19. Hua Wang, Jingyi Wu, Lixia Yuan, Zhen Li, and Yunhui Huang, Stable Lithium Metal Anode Enabled by 3D Soft Host, ACS Appl. Mater. Interfaces 2020, 12, 25, 28337-28344.
20. A. J. Louli, Matthew Genovese, Rochelle Weber, S. G. Hames, E. R. Logan and J. R. Dahn, Exploring the Impact of Mechanical Pressure on the Performance of Anode-Free Lithium Metal Cells, Journal of The Electrochemical Society, 166 (8) A1291-A1299 (2019).
21. Ningbo Xu, Jingwen Shi, Gaopan Liu, Xuerui Yang, Jianming Zheng, Zhongru Zhang, Yong Yang, Research progress of fluorine-containing electrolyte additives for lithium ion batteries, Journal of Power Sources Advances 7 (2021) 100043.
22. Lei Fan, Houlong L. Zhuang, Lina Gao, Yingying Lu, Lynden A. Archer, Regulating Li deposition at artificial solid electrolyte interphases, J. Mater. Chem. A, 2017, 5, 3483-3492.
23. Jie Zhao, Lei Liao, Feifei Shi, Ting Lei, Guangxu Chen, Allen Pei, Jie Sun, Kai Yan, Guangmin Zhou, Jin Xie, Chong Liu, Yuzhang Li, Zheng Liang, Zhenan Bao and Yi Cui, J. Am. Chem. Soc. 2017, 139, 33, 11550-11558.
24. Gang Wang, Xunhui Xiong, Dong Xie, Xiangxiang Fu, Zhihua Lin, Chenghao Yang, Kaili Zhang, Meilin Liu, A Scalable Approach for Dendrite-Free Alkali Metal Anodes via Room-Temperature Facile Surface Fluorination, ACS Appl. Mater. Interfaces 2019, 11, 5, 4962-4968.
25. Jialiang Lang, Yuanzheng Long, Jiale Quc, Xinyi Luo, Hehe Wei, Kai Huang, Haitian Zhang, Longhao Qi, Qianfan Zhang, Zhengcao Li, Hui Wu, One-pot Solution Coating of High Quality LiF Layer to Stabilize Li Metal Anode, 16, 2019, 85-90.
26. Seho Sun, Seungcheol Myung, Gaeun Kim, Dongsoo Lee, Hyunsu Son, Minchul Jang, Eunkyung Park, Byoungkuk Son, Yeon-Gil Jung, Ungyu Paik and Taeseup Song, Facile ex-situ formation of a LiF-polymer composite layer as an artificial SEI layer on Li metal by simple roll-press processing for carbonate electrolytes-based Li metal batteries, J. Mater. Chem. A, 2020, 8, 17229-17237.
27. Liu, Y., Lin, D., Liang, Z. et al. Lithium-coated polymeric matrix as a minimum volume-change and dendrite-free lithium metal anode. Nat Commun 7, 10992 (2016).
28. Jialiang Lang, Yuanzheng Long, Jiale Qu, Xinyi Luo, Hehe Wei, Kai Huang, Haitian Zhang, Longhao Qi, Qianfan Zhang, Zhengcao Li, Hui Wu, One-pot solution coating of high quality LiF layer to stabilize Li metal anode, Energy Storage Materials, 16, 2019, 85-90.
29. Salimi, A. & Yousef, A. A. Conformational changes and phase transformation mechanisms in PVDF solution-cast flms. J Polym Sci Part B: Polym Phys. 42, 3487-3495 (2004).
30. Boccaccio, T., Bottino, A., Capannelli, G. & Piaggio, P. Characterization of PVDF membranes by vibrational spectroscopy. J Membr Sci. 210, 315 (2002).
31. Gregorio, R. Determination of the α, β, and γ crystalline phases of poly(vinylidene fuoride) flms prepared at different conditions. J Appl Polym Sci. 100, 3272-3279 (2006).
32. Manna, S. & Nandi, A. K. Reply to “comment on ‘preparation and characterization of silver-poly(vinylidene fluoride) nanocomposites: formation of piezoelectric polymorph of poly(vinylidene fuoride. J. Phys. Chem. B. 115, 12325-12326 (2011).
33. Mandal, D., Henkel, K. & Schmeißer, D. Improved performance of a polymer nanogenerator based on silver nanoparticles doped electrospun P (VDF-HFP) nanofbers. Phys. Chem. Chem. Phys. 16, 10403-10407 (2014).
34. Rui Xu, Xue-Qiang Zhang, Xin-Bing Cheng, Hong-Jie Peng, Chen-Zi Zhao, Chong Yan, and Jia-Qi Huang, Artificial Soft-Rigid Protective Layer for Dendrite-Free Lithium Metal Anode, Adv. Funct. Mater. 2018, 1705838.
35. Suogang Guo, Nan Piao, Li Wang, Hong Xu, Guangyu Tian, Jiangang Li, and Xiangming He, PVDF-HFP/LiF composite interfacial film to enhance the stability of Li-metal anodes, ACS Appl. Energy Mater. 2020, 3, 7, 7191-7199.
36. Xianguo Yu, Jingying Xie, Ying Li, Haijiang Huang, Chunyan Lai, Ke Wang, Stable-cycle and high-capacity conductive sulfur-containing cathode materials for rechargeable lithium batteries, Journal of Power Sources 146 (2005) 335-339.
37. X. Yu, J. Xie, J. Yang, H. Huang, K. Wang, Z. Wen, Lithium storage in conductive sulfur-containing polymers, J. Electroanal. Chem. 2004, 573, 121.
38. Tae Hoon Hwang, Dae Soo Jung, Joo-Seong Kim, Byung Gon Kim, and Jang Wook Choi, One-Dimensional Carbon-Sulfur Composite Fibers for Na—S Rechargeable Batteries Operating at Room Temperature, Nano Lett. 2013, 13, 9, 4532-4538.
39. J. Wang, J. Yang, C. Wan, K. Du, J. Xie, N. Xu, Sulfur Composite Cathode Materials for Rechargeable Lithium Batteries, Advanced Functional Materials, 2003, 13, 487-492.
40. Hwang, T. H., Jung, D. S., Kim, J. S., Kim, B. G. & Choi, J. W. One dimensional carbon-sulfur composite fibers for Na—S rechargeable batteries operating at room temperature. Nano Lett. 13, 4532-4538 (2013).
41. Wei, S., Ma, L., Hendrickson, K. E., Tu, Z. & Archer, L. A. Metal-sulfur battery cathodes based on PAN-sulfur composites. J. Am. Chem. Soc. 137, 12143-12152 (2015).
42. Shuya Wei, Lin Ma, Kenville E. Hendrickson, Zhengyuan Tu, and Lynden A. Archer, Metal-Sulfur Battery Cathodes based on PAN-Sulfur Composites, J. Am. Chem. Soc. 2015, 137, 37, 12143-12152.
43. Wenxi Wang, Zhen Cao, Giuseppe Antonio Elia, yingqiang Wu, Wandi Wahyudi, Edy Abou-Hamad, Abdul-Hamid Emwas, Luigi Cavallo, Lain-Jong Li, and Jun Ming, Recognizing the Mechanism of Sulfurized Polyacrylonitrile Cathode Material for Li—S Battery and beyond in Al—S battery, ACS Energy Lett. 2018, 3, 12, 2899-2907.

1. A method of making a solid electrolyte interphase protected anode, comprising steps of:
a. applying a fluoropolymer film to a lithium metal surface to form a coated lithium metal surface,
b. applying pressure to the fluoropolymer film on the coated lithium metal surface,
c. subsequent to step b), dissolving at least part of the fluoropolymer film on the coated lithium metal surface in a solvent;
d. applying pressure to the at least partially dissolved fluoropolymer film on the coated lithium metal surface of step c); and
e. evaporating the solvent to form the solid electrolyte interphase protected anode.

2. The method of claim 1, wherein the fluoropolymer film of step a) is prepared by:
dissolving the fluoropolymer in an organic solvent at a weight ratio of fluoropolymer to solvent of 1:0.5 to less than 1:9 to form a fluoropolymer solution; and
applying the fluoropolymer solution to a surface; and
evaporating the solvent to form the fluoropolymer film.

3. The method of claim 1, wherein the fluoropolymer film has a thickness of 1 μm-15 μm.

4. The method of claim 1, wherein the fluoropolymer is selected from the group consisting of polyvinylidene fluoride, and polyvinylidene fluoride-hexafluoropropylene.

5. The method of claim 1, wherein the solvent is selected from the group consisting of dimethyl formamide, acetone, ethylene carbonate, propylene carbonate, and ethyl methyl carbonate.

6. The method of claim 1, wherein each step of applying pressure is carried out by roll pressing at about 0.1 rpm to about 0.5 rpm.

7. The method of claim 1, wherein the step c) of dissolving at least part of the fluoropolymer film partially defluorinates the fluoropolymer such that the artificial solid electrolyte interphase protected anode comprises a molar ratio of C—F bonds to Li—F bonds of 1:1 to 5:1.

8. The method of claim 1, wherein the artificial solid electrolyte interphase protected anode has a total thickness of from about 1 μm-100 μm.

9. The method of claim 1, wherein step c) is carried out using a microporous membrane separator and the microporous membrane separator comprises a material selected from the group consisting of polypropylene or polyethylene.

10. The method of claim 1, wherein each said evaporating step is carried out by air drying.

11. An artificial solid electrolyte interphase protected anode prepared by the method of claim 1.

12. A cell comprising the artificial solid electrolyte interphase protected anode of claim 11, an electrolyte, and a cathode.

13. The cell of claim 12, wherein the cathode comprises one or more of sulfur, graphite, sulfurized carbon, LiFePO4 (LFP), LiMn2O4 (LMO), lithium nickel manganese spinel (LNMO), lithium cobalt oxide, V2O5, lithium nickel cobalt manganese oxide (NMC), and electrically conductive polymers.

14. The cell of claim 12, wherein the cathode is prepared by:
a. mixing a conductive polymer, a nitrogen-containing polymer, or a combination of a conductive polymer and a nitrogen-containing polymer with sulfur in the presence of a solvent to form a mixture, wherein a weight ratio of the conductive polymer and/or nitrogen containing polymer to the sulfur is from about 1:2 to about 1:8; and
b. heating the mixture to a temperature of from about 250° C. to about 400° C. under a pressure of from about 0.05 bar to about 2.0 bar to form the cathode.

15. The cell of claim 12, wherein the electrolyte is a carbonate electrolyte selected from the group consisting of ethylene carbonate, dimethylcarbonate, methylethyl carbonate, diethylcarbonate, propylene carbonate, vinylene carbonate, allyl ethyl carbonate, and mixtures thereof.

16. A battery comprising one or more of the cells according to claim 12.

17. The battery of claim 16, having an energy density of about 450 W-h/kg to about 700 W-h/kg based on the weight of the battery.

18. An artificial solid electrolyte interphase protected anode comprising: a partially defluorinated fluoropolymer matrix, and lithium fluoride dispersed in the partially defluorinated fluoropolymer matrix.

19. The artificial solid electrolyte interphase protected anode of claim 18, comprising a molar ratio of C—F bonds to Li—F bonds of no less than 1.

20. The artificial solid electrolyte interphase protected anode of claim 18, wherein the fluoropolymer is selected from the group consisting of polyvinylidene fluoride, and polyvinylidene fluoride-hexafluoropropylene.
